(19) United States
(12) Patent Application Publication
(10) Pub. No.: US 2006/0268559 A1
(43) Pub. Date: Nov. 30, 2006

(54) Foldable Housing for a Light Fixture and Method of Assembly

(76) Inventors: James P. Sferra, Goshen, OH (US); Steven Proner, Woodstock, NY (US)

Correspondence Address: HASSE & NESBITT LLC, 8837 CHAPEL SQUARE DRIVE, SUITE C, CINCINNATI, OH, 45249, US

(21) Appl. No.: 11/419,361

(22) Filed: May 19, 2006

Related U.S. Application Data
(60) Provisional application No. 60/684,507, filed on May 25, 2005.

(51) Int. Cl. F21V 19/00

(52) U.S. Cl. 362/382

(57) ABSTRACT

A housing for light fixtures or the like and method for assembly of the housing, wherein a sheet of suitable material and thickness is formed having a peripheral shape in a pattern corresponding to the desired shape of the fixture housing when folded, and includes a plurality of fold lines along which the sheet is folded into the intended housing shape.

### CROSS REFERENCE TO RELATED APPLICATIONS

The present application claims the benefit of co-pending U.S. provisional patent application 60/684,507, filed May 25, 2005.

### FIELD OF THE INVENTION

The present invention relates generally to luminaires and other light fixtures and, more particularly, to a foldable housing for light fixtures and method for assembly of the housing.

### BACKGROUND OF THE INVENTION

Manufacturers who ship assembled lighting fixture units for installation in industrial, commercial or residential settings often incur labor intensive assembly costs at the manufacturing and assembly plant, with the attendant result that the completed fixtures can be large and bulky. Packaging and shipping costs for the units can therefore be considered excessive. The manufacturers have therefore typically resorted to shipment separately of the fixture components or partially assembled units for assembly by the installation workers at the job site. However, the assembly, packaging and shipment separately of the housings for the light fixture units remain substantially labor intensive and costly for the manufacturer. There is therefore indicated a need for light fixture housings that can be inexpensively produced and shipped and which can be easily assembled on-site by the installation workers.

### SUMMARY OF THE INVENTION

The present invention overcomes the foregoing and other shortcomings and drawbacks of housings for luminaires and other light fixtures by providing a foldable housing and method for assembly of the housing, wherein a sheet of suitable material and selected thickness is formed having a peripheral shape corresponding to the desired shape of the fixture housing when folded, and includes a plurality of fold lines along which the sheet is folded into the intended housing shape. While the invention will be described in connection with certain embodiments, it is noted that variations to the invention can be made by one with skill in the applicable arts within the spirit of the invention and the scope of the appended claims.

In accordance with the teachings of the present invention, a foldable housing for a light fixture, and method for assembly of the housing, are provided that comprise a single sheet or panel of material foldable to the desired housing shape for enclosing all or part of the light fixture electrical hardware components, such as wiring, ballast and light source.

The foldable housing of the invention is formed from a single sheet or panel, many of which can be nested or stacked and nested as a relatively small package and shipped at minimal expense to a building site for final assembly and installation on-site. The invention eliminates the need to provide labor and tooling at the factory to perform the multiple bends or folds to assemble the housing prior to shipment. The foldable sheet is configured to permit folding and assembly by either the manufacturer's assembly line workers or workers on-site and requires only a minimum of skill and tooling to perform the assembly.

The foregoing described objects and advantages of the invention will become apparent as the detailed description of representative embodiments proceeds.

### BRIEF DESCRIPTION OF THE DRAWINGS

The invention will be more clearly understood and appreciated from the following detailed description of representative embodiments thereof read in conjunction with the accompanying drawings.

FIG. 1 is a plan view of a representative sheet of material having a peripheral shape in a pattern corresponding to the shape of one representative housing fixture embodiment when folded according to the teachings of the invention.

FIG. 2 is a perspective view of a representative light fixture housing formed by folding the sheet of FIG. 1 to the desired shape.

FIG. 3 is a plan view of a representative sheet of material having a peripheral shape in a pattern corresponding to the shape of a second representative housing fixture when folded according to the teachings of the invention.

FIG. 4 is a perspective view of a second representative light fixture housing formed by folding the sheet of FIG. 3 to the desired shape.

### DETAILED DESCRIPTION OF SPECIFIC EMBODIMENTS

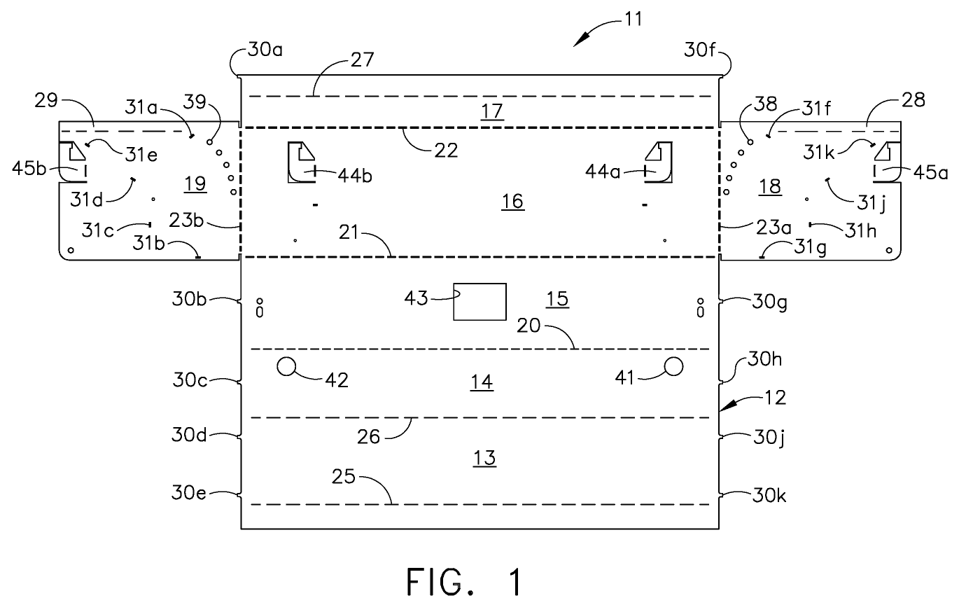

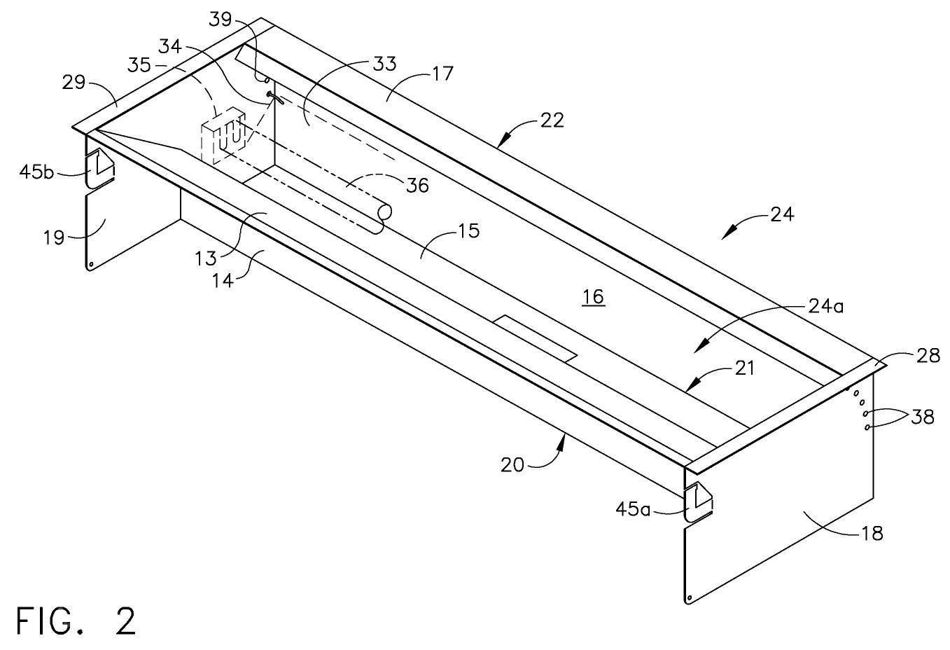

Referring now to the drawings, FIG. 1 shows a plan view of a representative sheet member 11 pattern having a peripheral shape 12 that results in the shape of one representative housing fixture when folded according to the teachings of the invention. FIG. 2 is a perspective view of a representative light fixture housing 24 formed by folding sheet 11. Sheet 11 of FIG. 1 is formed from substantially any suitable sheet material consistent with the end use of the folded housing as an enclosure for a lighting fixture, such as a sheet of steel, aluminum, or other metals or alloys suitable for the intended use as might occur to the skilled artisan guided by these teachings. Certain plastic or reinforced plastic (composite) materials that display the needed structural strength and foldability can also be used as would occur to one skilled in the art practicing the invention. The sheet 11 can have applied to the surfaces thereof any suitable coating for aesthetic purposes or for corrosion resistance or other protections. Accordingly, sheet 11 can be painted, plated, galvanized, plasticized, or otherwise coated conventionally before or after folding into the intended housing shape. In the non-limiting examples described herein that were built in demonstration of the invention, sheet 11 consisted of 30 gauge (0.030 inch) steel sheet pre-painted white.

The peripheral shape 12 of sheet 11 as suggested in FIG. 1 can be accomplished by any suitable metal cutting process such as die cutting, turret-and-tool, laser cutting or other conventional process to define a plurality of sheet portions 13,14,15,16,17,18,19 corresponding to interior and exterior surfaces of the assembled light fixture housing after folding as taught herein and shown in the representative structure of FIG. 2. The invention described herein is not considered limited to the specific pattern and size for the foldable sheet specifically depicted herein or to the light fixture housing structural shape resulting therefrom. Many sheet 11 and corresponding housing shapes and sizes are contemplated herein within the scope of the appended claims.

In order to permit the manual folding of sheet 11 into the corresponding housing shape, such as that shown in FIG. 2, some or all of the portions 13-19 may be separated from adjacent portions by fold lines 20,21,22,23a,23b shown in FIG. 1 by dashed lines defined by a series of closely spaced perforations in the form of apertures, slits, or slots, or by scoring or other means to weaken sheet 11 along the fold lines to facilitate manual folding of sheet 11. Perforations defining fold lines 20-23 can be made by any suitable conventional process including punching, stamping, boring, drilling, scoring, machining, grinding, laser drilling or other process, the same not considered limiting of the invention.

The representative sheet 11 depicted in FIG. 1 is formed in a pattern having a peripheral shape 12, sheet portions 13-18 and loci of fold lines 20-23 to define in the assembled condition housing 24 shown in FIG. 2. Once folded to the preselected shape, portions 13-19 define the corresponding internal and external surfaces (sides) of the assembled and substantially closed light fixture housing of FIG. 2. An opening 24a is defined by certain folded portions of sheet 11 (viz., portions 13,16,17,18,19 of housing 24) through which light is passed outwardly from a light source disposable within housing 24, or to access a light source and other electrical components and optionally a reflector and diffuser panel attachable on or within housing 24 that define a complete operable light fixture as more fully described below. In order to facilitate the assembly of housing 24 into its precise intended shape, certain factory produced partial folds along lines 25,26,27 in sheet 11 can optionally be provided, as not being easily manually produced to the precise intended angle on-site when folded by hand, and optional flanges 28,29 can be factory produced as being difficult to bend manually but which may be useful as means for supporting the completed housing as installed on-site. However, sheet 11 can in its basic generic form comprise a flat member with fold lines along lines 25,26,27 in addition to those along fold lines 20-23. It is noted that the fold lines define the various corners of the assembled housing 24 as shown more clearly in FIG. 2. As suggested in FIG. 2, a housing contemplated by the invention need not have a regular rectangular shape in order to accommodate the mounting of a light source therewithin or to facilitate its use as an illumination source.

Sheet 11 further includes optional means for interconnecting abutting adjacent sheet portions in the folded and assembled condition depicted in FIG. 2. Accordingly, a plurality of bendable tabs 30a-k are included at selected places on the periphery of sheet 11 on the edges of selected portions (such as portions 13,14,15,17) as suggested in FIG. 1, and a corresponding plurality of holes or slots 31a-k defined on selected other portions (namely, portions 18,19) are provided to receive respective tabs 30a-k in the assembly of housing 24 more fully described below. Other means for joining adjacent portions in forming the assembled housing 24 according to the invention include frog eye joints instead of the tab-and-slot structure just described, or the assembly can be accomplished using soldering, welding or other conventional joining techniques, the specific joining means not considered limiting of the invention.

Referring now to FIG. 1 in conjunction with FIG. 2, the assembly method for housing structure 24 can be summarized as follows. It should be noted at the outset that the specific order of folding and joining steps in the representative assembly method here described for housing 24 using sheet 11 of FIG. 1 can differ in sequence or detail from the steps appropriate for other sheet patterns and housing structures contemplated hereunder and within the scope of the appended claims, but it will be appreciated by one skilled in the applicable art that the essential assembly steps here described apply generally to other sheet pattern shapes and corresponding housing structures.

The folding method for sheet 11 of FIG. 1 may begin by first folding portion 14 downwardly (with respect to the plane of the drawing of FIG. 1) along fold line 20 until perpendicular to portion 15. Portion 15 is then folded downwardly along fold line 21 until perpendicular to sheet portion 16. Portion 17 is then folded downwardly along fold line 22 until perpendicular to sheet portion 16. The end portions 18 and 19 are then folded downwardly along respective fold lines 23a and 23b until perpendicular to portion 16, and the tabs 30a-k are inserted into the corresponding holes 31a-k in portions 18,19 and bent or twisted to secure the assembly of housing 24 shown in FIG. 2.

After assembly of housing 24 as just described, the additional components needed to render the assembly a complete lighting unit may be installed within the housing structure. Accordingly, a reflector 33 of suitable shape can be mounted within housing 24 and secured by spring loaded pins 34 or other attachment means (screws, clips, or the like) and receptacle 35 (or a pair of receptacles) having wiring and ballast (not shown) connected thereto and light source 36 can be mounted conventionally within housing 24 as suggested in FIG. 2. Holes 38,39 in sheet portions 18,19 facilitate adjustable mounting of reflector 33 and pins 34, and suitable apertures 41,42,43 can be provided in one or more portions of sheet 11 for receiving wiring or other electrical components required for connection to an outside power source in rendering the light fixture operable. Optional tabs 44a,b and 45a,b can be formed in the sheet 11 as originally produced and bent outwardly in the assembled condition of housing 11 to provide means for mounting or hanging the housing at the installation site.

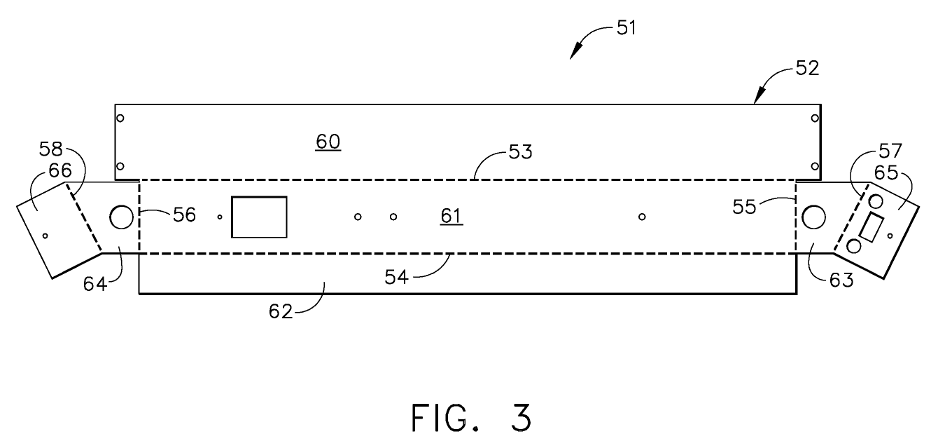

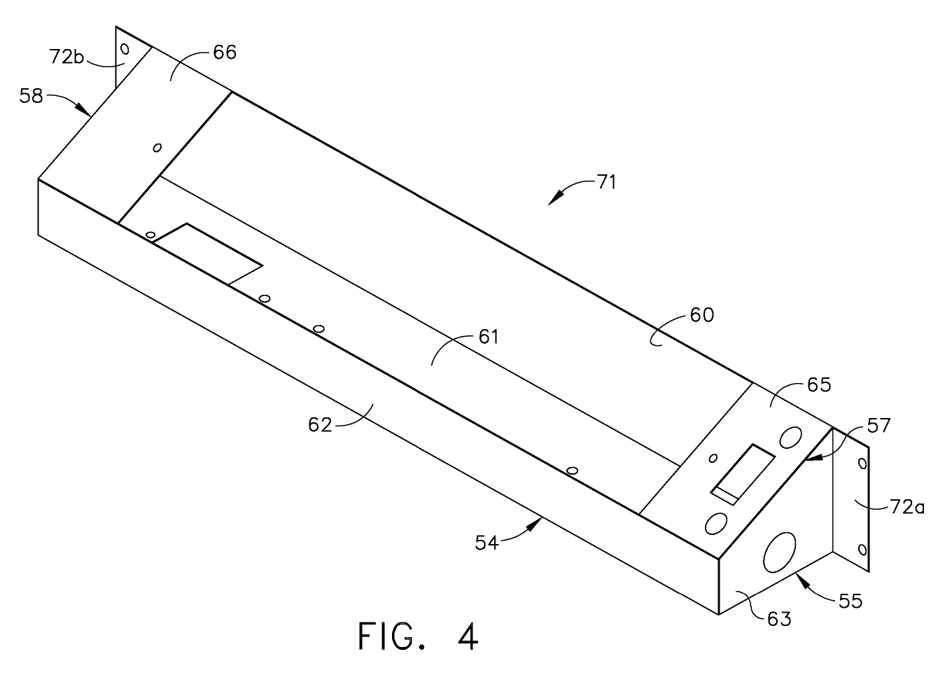

Referring now to FIG. 3, shown therein is a plan view of a representative sheet 51 of material in a pattern corresponding to the shape of a second representative housing fixture when folded according to these teachings, and FIG. 4 shows a perspective view of the light fixture housing formed by folding the sheet material of FIG. 3 to the desired shape. A plurality of fold lines 53,54,55,56,57,58 in sheet 51, formed similarly to those of the FIG. 1 embodiment, define a plurality of sheet portions 60,61,62,63,64,65,66 defining corresponding internal and external surfaces (sides) of the assembled light fixture housing 71 of FIG. 4. Similarly to the embodiment of FIGS. 1 and 2, the fold lines 53-58 define the various corners of the assembled housing 71 of FIG. 4.

The folding method for sheet 51 of FIG. 3 may begin by first folding portion 62 upwardly (with respect to the plane of the drawing of FIG. 3) along fold line 54 until perpendicular to portion 61. Portion 60 is then folded upwardly along fold line 53 until perpendicular to portion 61. Portions 63,65 are folded upwardly along fold lines 55,57 and portions 64,66 are folded upwardly along fold lines 56,58 to form the substantially closed respective ends of housing 71 as suggested in FIG. 4. In the embodiment of FIGS. 3 and 4, optional slots and tabs or other means (not shown) for joining the corners of housing 71 in the folded condition could be included in the housing 71 structure. It is noted that in the structure of housing 71, optional mounting flanges 72a,b can be made integral with sheet 51 such as at portion 60. The respective ends of housing 71 enclosed by folded portions 63,65 and 64,66 are configured to receive and enclose the additional electrical components needed to render the assembly a complete lighting fixture.

The invention therefore provides a manually foldable housing for light fixtures and method for assembly of the housing. It is understood that modifications to the invention can be made as might occur to one with skill in the field of the invention within the scope of the appended claims. All embodiments contemplated herein which achieve the objects of the invention have therefore not been shown in complete detail. Other embodiments can be developed without departing from the spirit of the invention or from the scope of the appended claims.

We claim:

1. A housing for a light fixture or the like, comprising: a sheet of material having a peripheral shape in a pattern corresponding to a preselected shape of a housing in a folded condition, the sheet of material having a plurality of fold lines, along which fold lines the sheet is rendered foldable to the preselected shape, the fold lines defining a corresponding plurality of sheet portions, and wherein two or more of the sheet portions define an opening in the housing in the folded condition for passing light outwardly from a light source disposable within the housing.

2. The housing of claim 1 further comprising means for interconnecting abutting adjacent sheet portions in the folded condition.

3. The housing of claim 1 wherein the fold lines in the sheet are lines of closely spaced perforations in the sheet.

4. The housing of claim 1 wherein the sheet comprises a material selected from the group consisting of metals, alloys, and plastics.

5. The housing of claim 2 wherein the means for interconnecting adjacent sheet portions includes slots and bendable tabs on respective adjacent portions, or solder joints, welded joints, or frog eye joints.

6. The housing of claim 1 wherein the sheet includes at least one opening defined therein for receiving electrical power supply wiring.

7. The housing of claim 6 further comprising at least one bendable tab defined in at least one of the sheet portions for mounting the housing.

8. A method for making a housing for a lighting fixture or the like, comprising the steps of:
a) providing a sheet of material having a peripheral shape in a pattern corresponding to a preselected shape of a housing in a folded condition;
b) forming a plurality of fold lines in the sheet, the fold lines defining a corresponding plurality of sheet portions, wherein two or more of the sheet portions define an opening in the housing in the folded condition for passing light outwardly from a light source disposable within the housing; and
c) folding the sheet along the fold lines to form the preselected shape of the housing.

9. The method of claim 8 wherein the fold lines in the sheet comprise lines of closely spaced perforations in the sheet.

10. The method of claim 8 further comprising the step of interconnecting abutting adjacent sheet portions in the folded condition.

11. The method of claim 10 wherein the sheet includes on the periphery thereof a plurality of tabs and at least two the sheet portions include a corresponding plurality of apertures for receiving the tabs in the folded condition of the housing, and the step of interconnecting abutting adjacent sheet portions in the folded condition includes interconnecting the tabs and apertures and bending the tabs in an assembled condition of the housing.

12. The method of claim 10 wherein the step of interconnecting abutting adjacent sheet portions includes soldering or welding.

13. The method of claim 8 wherein the sheet comprises a material selected from the group consisting of metals, alloys, and plastics.

14. The method of claim 8 further comprising the step of forming at least one opening in the sheet for receiving electrical power supply wiring into the housing.

15. The method of claim 8 further comprising the step of forming at least one bendable tab in at least one of the sheet portions for mounting the housing.

16. A light fixture, comprising:
a) a housing formed from a sheet of material having a peripheral shape in a pattern corresponding to a preselected shape in a folded condition, the sheet including a plurality of fold lines along which fold lines the sheet is rendered foldable to the preselected shape, the fold lines defining a corresponding plurality of sheet portions, and wherein two or more of the sheet portions define an opening in the housing in the folded condition for passing light outwardly from a light source disposable within the housing; and
b) a light source disposed within the housing.

17. The light fixture of claim 16 further comprising a reflector disposed within the housing near the light source.

18. The light fixture of claim 16 wherein the sheet includes at least one opening defined therein for receiving electrical power supply wiring into the housing for connection to the light source.

19. The light fixture of claim 16 further comprising means formed in or connected to the housing for mounting the light fixture.
